(19) United States
(12) Patent Application Publication
(10) Pub. No.: US 2001/0015089 A1
(43) Pub. Date: Aug. 23, 2001

(54) Gas sensor

(76) Inventors: Josef Kleinhans, Vaihingen (DE); Marie-Luise Beck, Vaihingen (DE); Hans Hecht, Korntal-Muenchingen (DE); Manfred Strohrmann, Karlsruhe (DE); Axel-Werner Haag, Stuttgart (DE); Andreas Stark, Lauscha (DE); Matthias Tews, Bietigheim-Bissingen (DE)

Correspondence Address: STRIKER, STRIKER & STENBY, 103 East Neck Road, Huntington, NY, 11743, US

(21) Appl. No.: 09/767,816

(22) Filed: Jan. 22, 2001

(30) Foreign Application Priority Data
Jan. 22, 2000 (DE) 100 02 707.5-52

(51) Int. Cl. G01N 7/00

(52) U.S. Cl. 73/23.2; 73/31.05

(57) ABSTRACT

A gas sensor for determining physical values of gasses has a capacitor with a dielectric which is bringable into contact with a gas so that a change of a physical property of the gas leads to a corresponding change of a dielectricity constant of the dielectric, and a gas layer arranged on the gas sensor in a region of the dielectric.

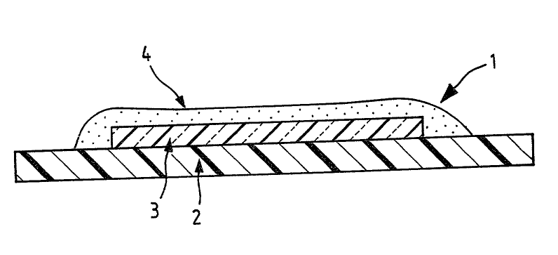

### BACKGROUND OF THE INVENTION

The present invention relates to a gas sensor, in particular for determination of a moisture content of a gas.

Sensors for determination of the moisture in a gas are known in the art. As a rule they measure water molecules adsorbed on the outer surface of the sensor or on the layers which are close to the outer surface. For example, by changing of dieletricity constants of the filling medium, i.e. the dielectric, a capacitor arranged for example in a layer technique on a carrier substrate detects a corresponding measuring value.

Such moisture sensors are used for example for the arrangement in a suction pipe of an internal combustion engine. The long term stability of the moisture sensors however can be here distorted, first of all by the adsorbed foreign matter in a sensitive way, since in this situation the deposit of water molecules is facilitated and can lead to disturbing dielectricity influences.

Hydrophobous materials such as hydrocarbon materials which are entrained in the aspirated air in a suction pipe reduce the moisture adsorption. Hydroscopic materials such as salts increase, to the contrary, the water or moisture adsorption. So-called fine-crystaline materials, such as silicate, lime or street dust moreover can facilitate the adsorption capacity for further substances (water, other fluids or other dusts) by their great, finely fissured surface. All above described influences can lead, in particular in view of their long term action, to falsifying of the measuring values of the gas sensors.

### SUMMARY OF THE INVENTION

Accordingly, it is an object of present invention to provide a gas sensor of the above mentioned general type, which avoids the disadvantages of the prior art.

In keeping with these objects and with others which will become apparent hereinafter, one feature of present invention resides, briefly stated, in a gas sensor for determination of physical values of gasses which has a capacitor with a dielectric in contact with the gas so that a change of the physical properties of the gas leads to a corresponding change of the dielectric constant.

In an advantageous manner, the gas sensor in accordance with the present invention is provided with a gel layer which is arranged on the gas sensor in the region of the dielectric.

The gas sensor in accordance with the present invention can be used in an especially advantageous manner when it is formed as a sensor for determination of moisture contact of the gas, while the gel layer can be composed for example of a silicone gel or fluorine gel.

The above mentioned moisture sensor measures water molecules which are adhered to its outer surface or in layers which are close to the outer surface, by the change of the dielectric constant of the dielectric in the capacitor. The capacitor of the gas sensor is composed in a known manner of plane-parallel layers or is formed as an interdigital structure.

When such a moisture sensor is coated with gel in accordance with the present invention, foreign substances of the dirtying, depending on their molecular structure, are held far from the moisture-sensitive layer of the capacitor, while the water to be determined reaches this layer easily by diffusion and can again leave it.

The protective action against the different dirt types can be different in same details. However, in each case it is expected for the main deposit quantity of the dirt that it is retained on the gel surface and does not reach the region of the electrical field of the capacitor. Thereby in each case a dirt action of the gel is available, and reduction of the drift of the capacitor over its service time is provided.

The above mentioned silicone or fluorine gels are very poorly crosslinked polymers. In other words, a solid body is provided, which is composed of long molecule threads seldomly connected with one another, so that an extremely low modulus of elasticity or modulus of displacement is produced. A lot of space is provided inside the solid body between the molecule threads of the gel, so that small molecules can be diffused into them.

Water in particular is located in a quasi vapor-shaped face inside the solid body and is therefore no longer in the liquid phase. Thereby an electrolytic short circuiting between the conductor tracks of a coated circuit, which forms the capacitor, is prevented. A further protective mechanism of the gel for the circuit surface is therefore provided, for example against a corrosion of the metallic outer surface of the capacitor.

The measuring values form a moisture signal in form of the capacity course of the capacitor. The moisture signal is not negatively worsened by the coating with the gel. Also, the reaction speed of the gas sensor to moisture changes is not substantially slowed with the relatively thin gel coatings of the circuit, which is produced with a size order of approximately 0.1-0.3 mm.

In accordance with an especially advantageous embodiment of the inventive gas sensor, it is arranged in a suction path of an internal combustion engine as a moisture sensor. An improvement of the measuring value with the gel layer can be also provided in comparable gas sensors, for example for alcohol, city gas or similar applications in an advantageous manner.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view showing an inventive gas sensor which is formed as a moisture sensor and illustrated in a schematic cross-section.

### DESCRIPTION OF PREFERRED EMBODIMENTS

A gas sensor in accordance with the present invention is illustrated as a moisture sensor and identified as a whole with reference numeral 1. It can be arranged for example in a suction path of an internal combustion engine and determines a moisture content of the gas which passes through the path.

The sensor 1 has a substrate which is identified with reference numeral 2. A capacitor with a dielectric 3 is arranged on the substrate 2. It represents a moisture-sensitive region. The capacitor of the moisture sensor 1 can be composed in a known manner of plane-parallel layers or formed as a so-called interdigital convertor.

A gel layer 4 is placed over the dielectric 3. It is composed for example of a silicone gel or a fluorine gel. For example, it has a size of approximately 0.1-0.3 mm. With this gel layer 4, foreign substances which are present in the passing gas are retained so that they do not reach the moisture sensitive layer of the dielectric 3 of the capacitor. The water to be detected for the moisture measurements, to the contrary, can reach this layer 3 easily by diffusion and can leave it again.

It will be understood that each of the elements described above, or two or more together, may also find a useful application in other types of constructions differing from the types described above.

While the invention has been illustrated and described as embodied in gas sensor, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A gas sensor for determining physical values of gasses, comprising a capacitor with a dielectric which is bringable into contact with a gas so that a change of a physical property of the gas leads to a corresponding change of a dielectricity constant of said dielectric; and a gas layer arranged on the gas sensor in a region of said dielectric.

2. A gas sensor as defined in claim 1, wherein said gel layer is composed of a silicone gel.

3. A gas sensor as defined in claim I, wherein said gel layer is composed of fluorine gel.

4. A gas sensor as defined in claim 1, wherein said capacitor is composed of a plurality of plane-parallel layers.

5. A gas sensor as defined in claim 1, wherein said capacitor is formed as an interdigital structure.

6. A gas sensor for determination of a moisture content of a gas, comprising a capacitor with a dielectric which is bringable into contact with a gas so that a change of a physical property of the gas leads to a corresponding change of a dielectricity constant of said dielectric; and a gas layer arranged on the gas sensor in a region of said dielectric.

7. A moisture sensor adapted to be arranged in a suction path of an internal combustion engine, the moisture sensor comprising a capacitor with a dielectric which is bringable into contact with a gas so that a change of a physical property of the gas leads to a corresponding change of a dielectricity constant of said dielectric; and a gas layer arranged on the gas sensor in a region of said dielectric.
